(19) United States
(12) Patent Application Publication
(10) Pub. No.: US 2016/0171615 A1
(43) Pub. Date: Jun. 16, 2016

(54) FLOOD PROTECTION AGREED VALUE PAYOUT AND LINEAR PAY WEBSITE & MOBILE APPLICATION

(71) Applicants: Rawle Oliver King, Fort Washington, MD (US); Oliver Robert Meissner, Washington, DC (US)

(72) Inventors: Rawle Oliver King, Fort Washington, MD (US); Oliver Robert Meissner, Washington, DC (US)

(21) Appl. No.: 14/569,723

(22) Filed: Dec. 14, 2014

(51) Int. Cl. G06Q 40/08

(52) U.S. Cl. CPC G06Q 40/08

(57) ABSTRACT

The present invention is a web-based mobile application, which would serve as a marketplace for agreed value and linear payout flood and other disaster-loss reimbursement protection system. The web application would integrate information about risk and disaster insurance products, including details relating to pricing, coverage and providers, from multiple providers into a single source on an online platform enabling risk-financing customers to compare and purchase risk-financing products entirely online. The web application would expedite the marketing and sale of flood and other disaster risk financing policies by insurance providers by creating a user-friendly, efficient marketplace for the listing and purchase of flood insurance. The web application would list policies guaranteeing a pre-agreed payout based on pre-determined metrics—for instance, in the case of flood hazards, a water-elevation function factoring in high water probability data and building structure elevation—saving both insurers and customers the time and money spent on building inspection and damage estimation.

### CROSS-REFERENCES TO RELATED APPLICATIONS

This application claims priority from provisional Application No. 61/963,939 entitled. “Flood Protection Agreed Value Payout and Linear Pay Website & Mobile Application”, filed on Dec. 19, 2013, which is hereby incorporated herein in its entirety.

### BACKGROUND OF THE INVENTION

The present invention relates generally to a customized web and mobile application for buying, selling, distributing, transferring, and/or hosting flood protection agreed value linear payout flood and other disaster insurance or risk-financing policies and other similar products online. This invention is a portal which enables seamless web integration of agreed value, linear payout and other risk/insurance policies for flood and other disaster related financial products, creating a marketplace for policy sellers, insurance agents and brokers, financial institution, home and business properties owners to easily sell, purchase, transfer, and distribute policies entirely or largely by going to a website, mobile application or combination thereof.

Current flood insurance policy paradigms often require inspectors to thoroughly inspect buildings after a flood in order to estimate damages. In response to Presidential declared disasters, the federal government usually pays huge sums of money in flood disaster assistance to compensate flood victims and fund reconstruction and recovery costs. The result is that there is a significant amount of money wasted in the process.

This invention enables homeowners and other property owners, for example, to enroll in plans, which have predetermined, payouts in the case of flooding, dependent solely on the depth in structure water depth reached by the flood, largely or entirely online. For the case of the current invention there are limited, if any, requirements for home inspections before and after flooding. Based on Federal Emergency Management Agency (FEMA) and other entity flood high water probability data corresponding to building structure elevation related to Base Flood Elevations (BFE), linear payout amounts are calculated based on water elevation metrics. For example, hypothetical flood depth in structure determinations corresponding to pre-agreed payouts are dependent on flood high water probabilities for certain locations, historic data, high resolution flood zone maps, GPS and other data.

Erlanger US Published Patent No. 2003/6,594,1635 B1 describes a data processing system which provides a marketplace for insurance instruments whereby insurers and insurance seekers use the system to exchange insurance instruments, and the provider is able to collect fees which are based on usage statistics which are compiled and calculated using the system.

Brown US Published Patent No. 2013/8,600,104 describes a system utilizing a sensor to acquire spectral images in order to assess the condition of property for insurance purposes. The sensor system has the capability to assess changes in the condition of a property over time and thereby affect insurance related actions.

Feyen US Published Patent No. 2008/7,395,157 describes a system to generate location dependent flood risk assessments for specific territories by incorporating data from distributed gauging stations which measure water depth values, and making probabilistic flood risk determinations thereof.

Celona US Published Patent No. 2013/8,589,189 describes a system which communicates insurance information from a plurality of insurance providers to users through a networked-based system and accompanying GUI, and methodologies for insurance plan recommendations.

Varanasi US Published Patent No. 2013/8,521,567 describes a system for an insurance exchange for providing a neutral, unbiased and automated lead generating platform in a one-stop shop setting, between a set of users and a set of providers, using a unique computer code, and allows users to compare benefits and prices, choose between different insurance products.

Weeks US Published Patent No. 2013/8,515,783 describes a risk assessment method for insurance coverage of an enterprise, which identifies enterprise risk and numerically scores activities against risk exposure factors, and subsequently binding coverage on the activities in question to risk ratings and associated potential premium rates, and includes automatic aspects such as declining, approving, or renewing coverage based on ratings.

Du US Published Patent No. 2011/7,917,292 describes a flood risk assessment system utilizing geospatial flood risk zoning maps to generate flood frequency versus flood elevation curves to reduce uncertainty in flood risk, assessment, and incorporates computerized mathematical models and flood elevation datasets.

### BRIEF SUMMARY OF THE INVENTION

The present embodiments provide a method for a customized web and mobile application (website/app) which can be used by flood hazard or other disaster policy providers (providers), government agencies, and homeowners and other building owners (homeowners), collectively called users, to provide agreed value, linear agreed value or other payout based (payouts) risk, insurance policies (policies). The website/app may be produced using computer programming involving HTML, Java, Javascript, PHP or other programming languages involving user interface (UI) design, front end, back end, database and other required functionalities. Global positioning system (GPS) and mapping data and functionality, and on-location visual data would be utilized to compile building, elevation, flood risk, and other data for specific addresses.

In one embodiment, the website/app displays payout options for a homeowner to view wherein linear payout amounts are listed corresponding to hypothetical achieved flood water depth in a structure (depth in structure). The payout amounts are calculated based on the estimated elevation of the homeowner's property, the probability of a flood event at various high water heights and resulting depth in structure for the homeowner's property. The website/app optionally displays a number of different policy options, from one or more providers, and the homeowner can choose the policy and payout amount, which is most attractive to him.

### BRIEF DESCRIPTION OF THE DRAWINGS

The above features and advantages of the invention as well as additional features and advantages thereof will be more clearly understood hereinafter as a result of a detailed description of embodiments of the invention when taken in conjunction with the drawings. Like reference numerals refer to corresponding parts throughout the several views of the drawings.

FIG. 1 illustrates a website/app flow chart in accordance with an embodiment of the present invention.

FIG. 2 illustrates an address-specific building with corresponding elevation and depth in structure marks.

FIG. 3 illustrates a plurality of address-specific buildings with respect to a body of water

FIG. 4 illustrates a user interface for the website/app

FIG. 5 illustrates a wearable eyeglass environment of the present invention wherein a user can select specific determine flood related information for specific addresses.

FIG. 6 illustrates a computing database and user delivery environment for the present invention.

### DETAILED DESCRIPTION OF THE INVENTION

To better understand the various embodiments of this invention, a discussion relating directly to the drawings follows.

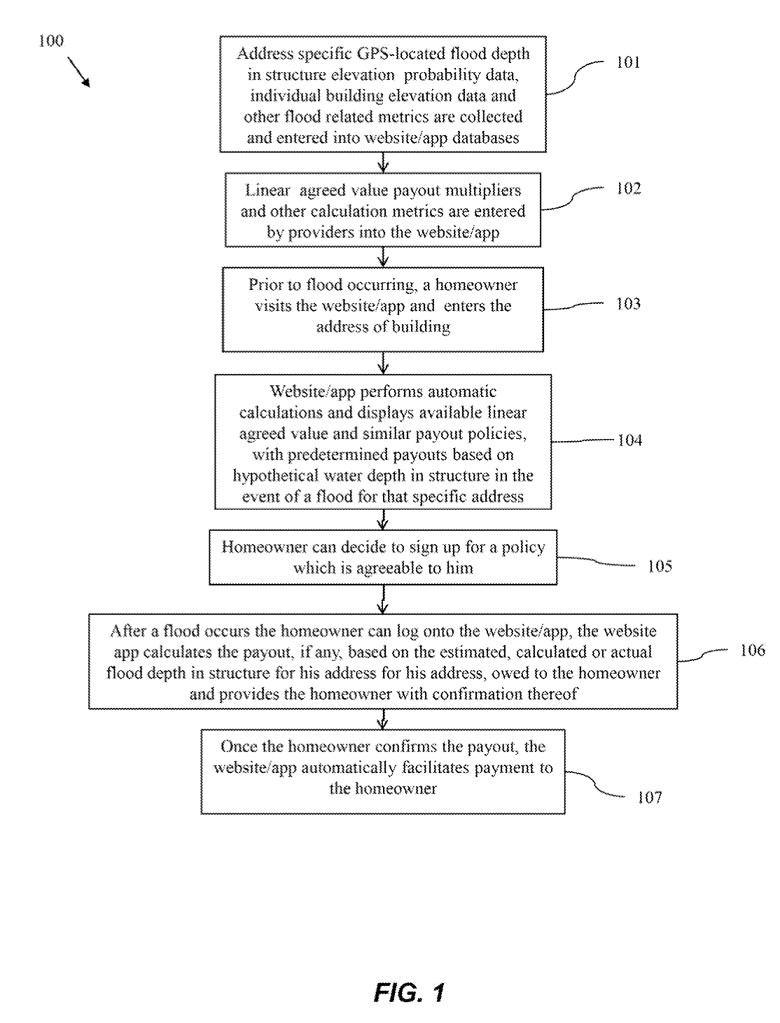

FIG. 1 depicts a website/app flow chart in accordance with an embodiment of the present invention. Address specific GPS-located flood depth in structure elevation probability data, individual building elevation data and other flood related metrics are collected and entered into website/app databases 101. Then, flood protection agreed value linear payout multipliers and other calculation metrics are entered by providers into the website/app 102. Prior to flood occurring, a homeowner visits the website/app and enters the address of building 103. Website/app performs automatic calculations and displays available flood protection agreed value and similar payout policies, with predetermined payouts based on hypothetical water depth in structure in the event of a flood for that specific address 104. Homeowner can decide to sign up for a policy which is agreeable to him 105. After a flood event occurs the homeowner can log onto the website/app, the website app calculates the payout, if any, based on the estimated, calculated or actual flood depth in structure for his address for his address, owed to the homeowner and provides the homeowner with confirmation thereof 106. Once the homeowner confirms the payout, the website/app automatically facilitates payment to the homeowner 107.

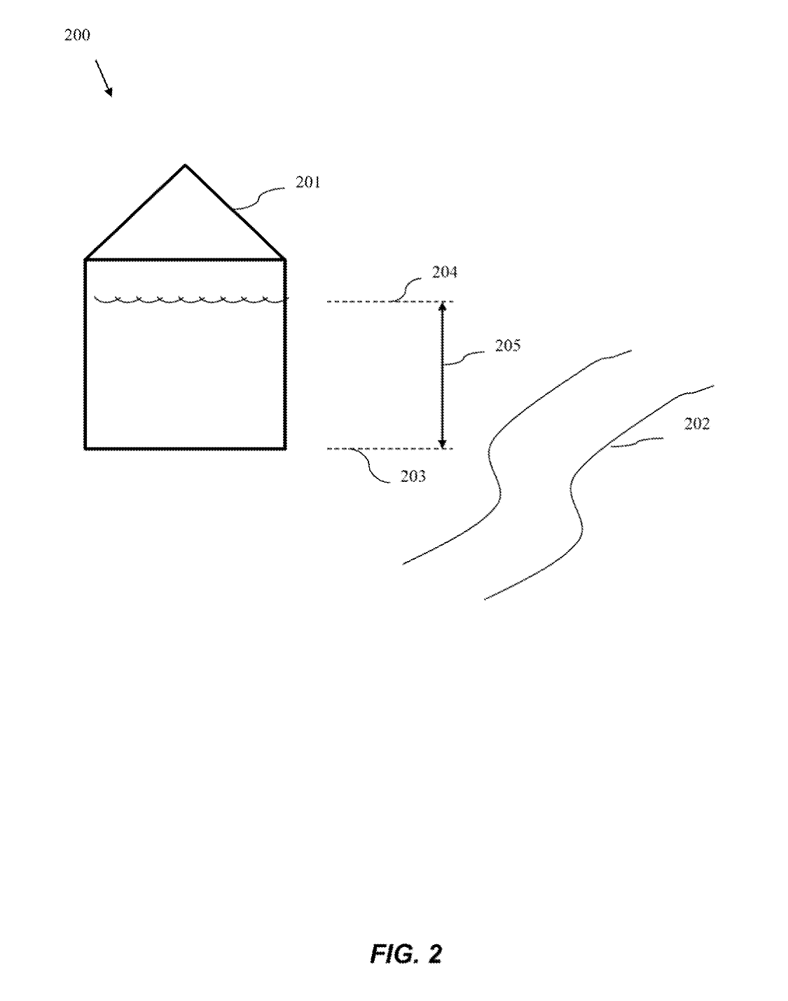

FIG. 2 depicts an address specific building 201 with flood risk from a body of water such as a river 202 or other source of high flood water. The building elevation 203 is recorded and entered into a database for the website/app. Probability for varying depth in structure 204 in the event of flooding, compared to the differential 205 with respect to the building elevation 203, are estimated and entered in to the database for the website/app prior to a flood event, and corresponding payouts are generated by the website/app for each depth in structure scenario. After a flood event the actual depth in structure 204 is entered into the website/app and confirmations of the actual payout owed to the homeowner/policy holder are calculated.

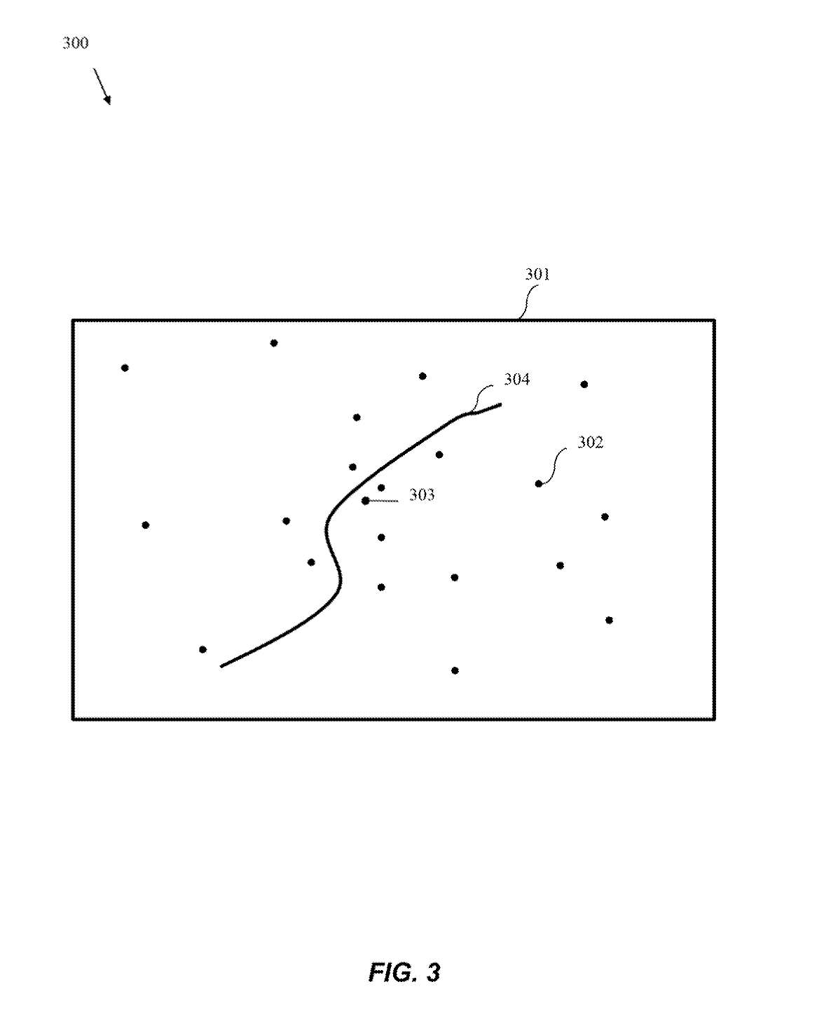

FIG. 3 depicts a user interface 301 of the website/app wherein are located a plurality of representations of address-specific buildings 302, 303 near a body of water, which could be a river, lake, stream, ocean or any other body of water. Users can select on specific address for a building and receive corresponding flood event related data.

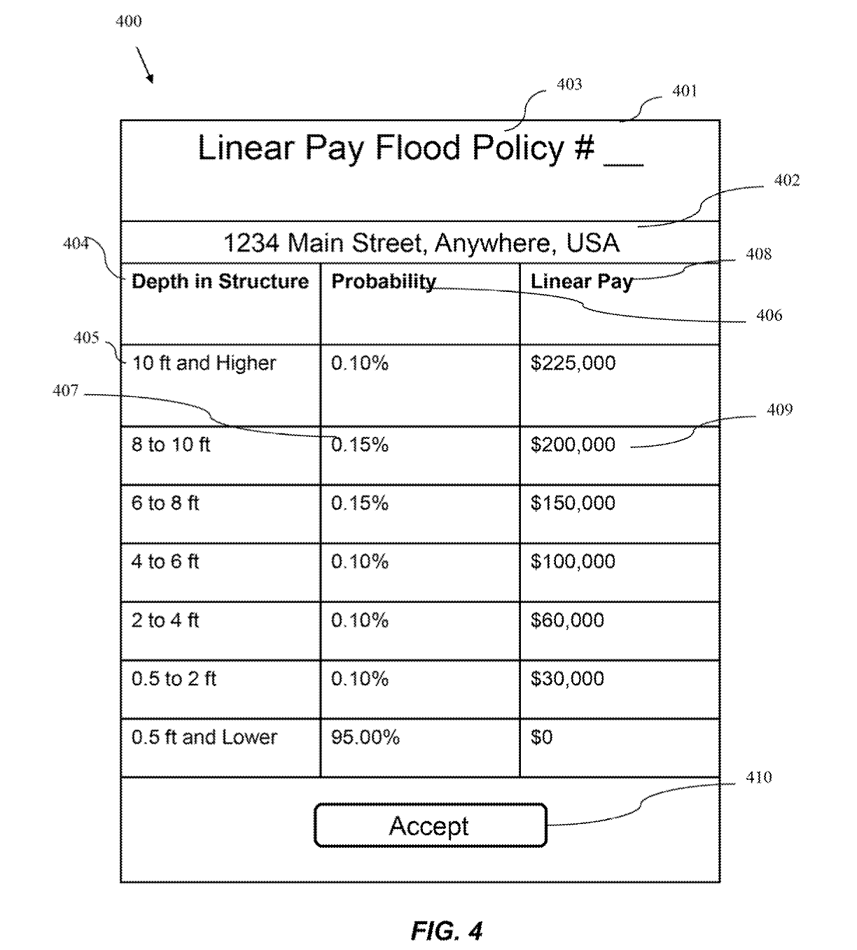

FIG. 4 depicts an example user interface page 401 of the website/app. The address for the building in question is entered in the address field 402, or automatically entered into the field based on account preferences, and a corresponding proposed policy offering 403 is displayed. The details of the policy are depicted outlining varying hypothetical depth in structure amounts 404, 405, corresponding probability of that depth in structure occurring 406, 407, and the corresponding agreed value linear payout for each depth in structure flooding occurrence 408, 409. The user can review the policy and if it is satisfactory, can select the accept button 410 and continue to finalize purchase of the policy.

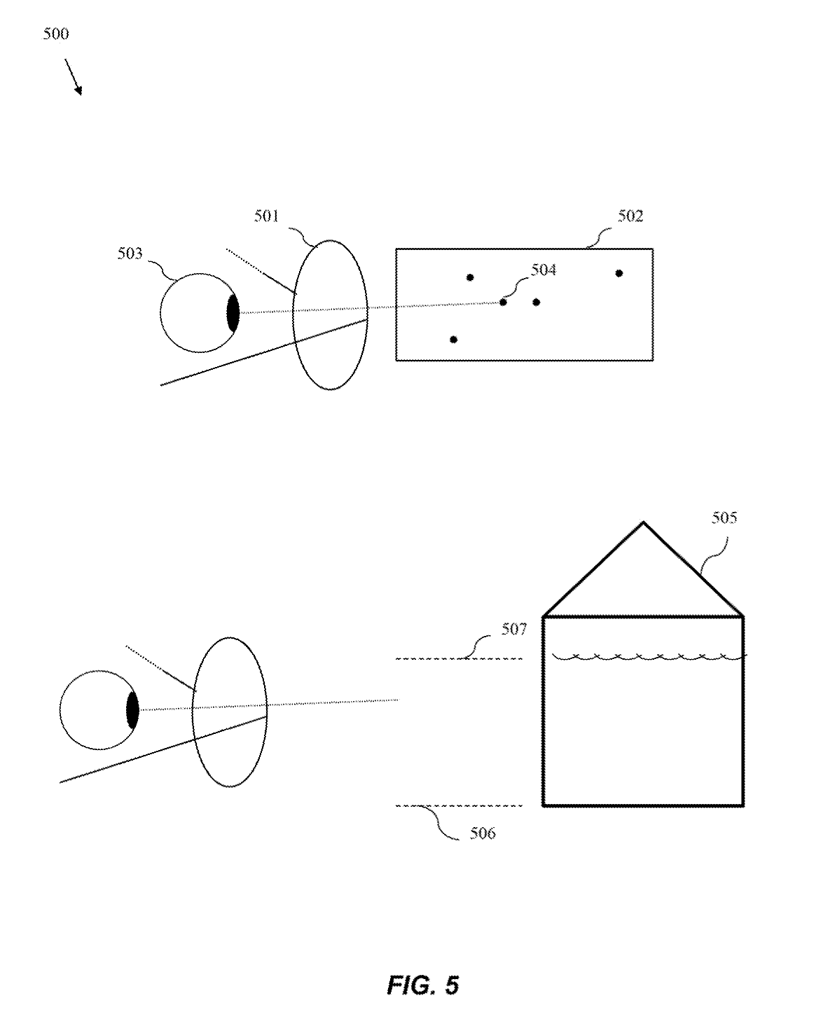

FIG. 5 depicts an environment wherein website/app data are viewed on a visual based computerized platform, such as Google Glass 501, on which the user can see the user interface 502 as an image in front of the user's eyes 503 as a projection, hologram or displayed via other optical technique. In addition to using a mouse, tooltip, hover or other type of offering selection method, the user can look at a representation of an specific address-specific building 504 on the user interface and use an eye-based selection method, such as blinking, staring, and thereby automatically selecting the offering or displaying an informational and/or actionable tooltip or popup regarding the offering. The visual based computerized platform can also be used to look at buildings 505 when, for example, walking or driving at specific locations, and receive information on the building elevation 506, hypothetical or actual depth in structure 507, for purposes including survey and analysis both prior to and after flood occurrence.

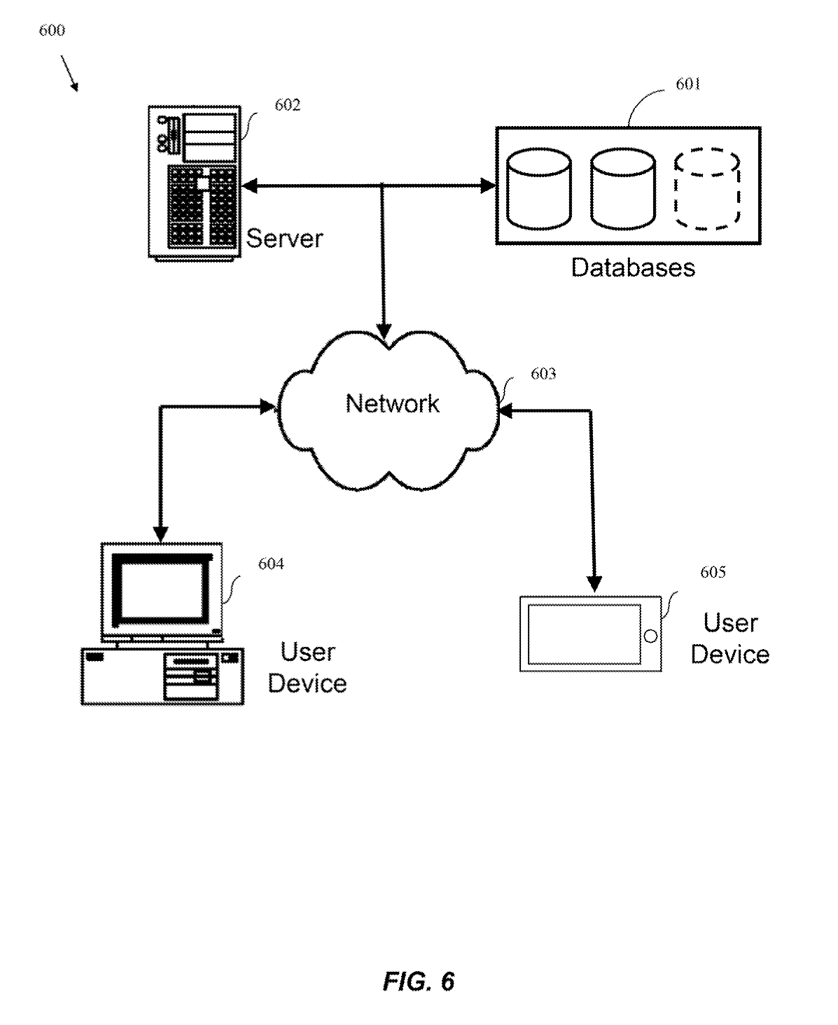

FIG. 6 depicts an example computing environment for the current invention. All flood related data for specific addresses and locations of a main database 601 of a provider are entered and stored on a server 602 operated by the provider. The databases are regularly updated and referenced programmatically either locally, or over a network 603, through computer programming code such as PHP language or other database programming languages. The main website/app front end which homeowners and other users see are accessed by the user over the network via internet signal on user devices such as a desktop computer 604, mobile device 605, or on other computerized devices.

In one embodiment, a homeowner visits the website/app and signs up for an account and inputs the address of the property the homeowner would like to view policies tar, or alternatively, the homeowner can just visit the website/app without an account and enter only the address for the building he would like to view policies for. Based on the inputted address, and prior to a flood, the website/app, after querying its database, and based on the structure elevation of the building represented by the inputted address compared to its government base flood elevation, returns to the homeowner one or more payout policies for their review. In addition to automatically calculating flood protection agreed value linear payouts, other factors such as deductibles, can be included in the calculations and in the policy details. If the homeowner has not yet signed up for an account with the website/app he is required to do so in order to proceed with the purchase of a policy. Once the homeowner is signed into his account, he then has the option to select one of the payout policies and proceed with payment arrangements on the website/app.

In one embodiment, the website/app is applicable to any areas which have a chance of flooding, whether from high waters from rivers, streams, flash floods, tsunami's, rainfall, tornadoes, hurricanes, typhoons, tropical storms, coastal areas, dam breakages and other sources of high water. In all cases the building elevation for specific addresses are compared with probabilities of the occurrence of depth in structure water levels due to flooding, and flood protection agreed value payouts are formulated.

In one embodiment, after a flood occurs, and assuming a homeowner has signed up for an account and signed up for a policy website/app prior to the flood, the homeowner can log on to the homeowner's account on the website/app. Based on the address for the homeowner, the website/app, after querying its database, and based on the structure elevation of the building represented by the inputted address compared to its corresponding location-specific government Base Flood Elevation (BFE), which is the elevation of a hypothetical flood having a one percent chance of being equated or exceeded in any given year, returns to the homeowner the payout which is owed to the homeowner based on the previously agreed-upon arrangement. The homeowner has the option to confirm and accept the payout presented on the website/app, and if acceptable, can select an option to confirm the payout amount. At that point the website/app automatically processes the required payout and the payout is processed and ultimately sent to the homeowner.

In one embodiment, prior to a flood, the website/app incorporates one or more databases of buildings, matched to specific addresses, respective building elevations based on Federal Emergency Management Agency (FEMA) or other government entity BFE, payout schedules which take into consideration flood occurrence and high water levels.

In one embodiment, data required to calculate payouts for specific building addresses are garnered from databases of Federal and local government agencies, nonprofits or other entities. Examples of such data include flood probability data, GPS located and mapped floodplain, high water mark probability and other flood related data, elevations of buildings at specific addresses mapped to GPS coordinates and other data. Such data may be sourced by entities incorporating GPS geo-location, government digital floodmap data, GPS based mapping systems, aerial surveillance, LIDAR sensing, other sourcing methods, or some combination thereof.

In one embodiment, in the event of a flood, the flood high water marks for various locations in the flood zone are automatically or manually entered into a database for the website/app. Flood high water mark data, from FEMA or other government authorities, and which is mapped to specific locations and addresses, is added to the database of the website/app by government authorities, or providers under government authority, and calculations are automatically made to determine payouts which are owed to homeowners who have signed up for policies.

In one embodiment, the website/app is accessible via a wearable computerized device such as Google Glass or another visual based computerized device, on which the user can see the website/app displayed as an image in front of the user's eyes as a projection, hologram or displayed via other optical technique. In addition to using a mouse, tooltip, hover or other type of offering selection method, the user can look at a specific offering on the GUI and use an eye-based selection method, such as blinking, staring, and thereby automatically selecting the offering or displaying an informational and/or actionable tooltip or popup regarding the offering. Providers, building owners and others can automatically receive flood related information pertaining to a specific building by either navigating on the screen of the wearable device, or by, for example, looking at a property to determine its flood related metrics such as structure elevation compared to base flood elevations and other metrics.

The invention has now been described in detail for purposes of clarity and understanding. However, it will be appreciated that certain changes and modifications may be practiced within the scope of the appended claims. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A website and mobile application portal (website/app) incorporating a graphical user interface (GUI) for use as a marketplace for buying, selling, hosting, providing claims information and/or payouts for flood protection agreed value, linear payout flood and other disaster insurance or risk-financing policies and other similar products (flood insurance policy) for insurance sellers, agents and brokers, financial institutions and home and business property owners and others to sell, purchase, transfer, and distribute policies, and conduct other transactions entirely or largely by going to a website, mobile application or combination thereof on a user device, with said website/app incorporating one or more government or private-sector generated databases of buildings and their respective locations and Base Flood Elevation (BFE) data, other flood probability data related to elevations, actual flood elevation data, high water marks, depth in structure and other metrics and factors, and corresponding payout schedules in the event of hypothetical floods of corresponding flood water elevation levels.

2. The method of claim 1, wherein the website/app is accessible via a website page, mobile website, application or app on a user device.

3. The method of claim 1, whereby a property owner or other individual or entity has the capability to select and purchase a flood insurance policy.

4. The method of claim 1, whereby Base Flood Elevation (BFE) data, other flood probability data related to elevations, actual flood elevation data, high water marks, depth in structure and other metrics and factors on specific buildings and corresponding mapped hypothetical flood water elevation data, and, in the event of a flood, actual flood water elevation data, at the location for said buildings, are incorporated into databases of the website/app.

5. The method of claim 3, whereby data is gathered via aerial surveillance, light detection and ranging (LIDAR) and other sensing systems, GPS based mapping systems, other methods or sonic combination thereof.

6. The method of claim 3, whereby data is sourced from government entities such as the Federal Emergency Management Agency (FEMA), National Oceanic Atmospheric Administration (NOAA), United States Geological Survey (USGS), and from nonprofits, private sector businesses and other organizations.

7. The method of claim 1, whereby the website/app automatically calculates, based on probabilities of flood water depths in structures corresponding to various hypothetical flood elevations for specific building locations relative to BFE and other metrics, agreed value linear payout amounts, which may also include outputs such as deductibles and other factors.

8. The method of claim 1, whereby users of the website/app have the ability to input information such as addresses of structures to the website/app and then view flood policy information such as types of policies and cost of coverage relative to agreed value linear payout amounts corresponding to particular locations.

9. The method of claim 1, whereby the website/app displays on the GUI proposed agreed value linear payout amounts, which may also include factors such as deductibles and other factors, from one or more insurance providers, corresponding to various hypothetical flood water depths in structure for a specific building location or locations specified by a user.

10. The method of claim 1, whereby the website/app automatically calculates the differential between building elevations at specific locations compared to the BFE corresponding to said specific locations.

11. The method of claim 1, whereby users have the ability to select a preferred flood insurance policy on the website/app, and make payment arrangements either directly through the website/app or indirectly, to finalize purchase of said flood insurance policy.

12. The method of claim 1, whereby in the event of a flood the payout amount agreed to by a user who bought a flood insurance policy prior to the flood, is automatically calculated and confirmed to said user by the website/app on request of said user.

13. The method of claim 12, whereby the website/app automatically sets up and facilitates the agreed value linear payout amount owed to the user.

14. The method of claim 1, wherein the website/app is accessible via a wearable computerized device such as Google Glass or another visual based computerized device.

15. The method of claim 14, wherein users can look at a building and, via a selection method, can automatically receive flood related information pertaining to the building.

16. The method of claim 1, wherein the GUI is incorporated into a third party website or social network.
